(19) United States
(12) Patent Application Publication
(10) Pub. No.: US 2007/0107856 A1
(43) Pub. Date: May 17, 2007

(54) Protective system for windows and doors, assembly and installation thereof

(76) Inventor: Fernando Villarello Cordova, Coyoacan (MX)

Correspondence Address: KNOBBE MARTENS OLSON & BEAR LLP, 2040 MAIN STREET, FOURTEENTH FLOOR, IRVINE, CA, 92614, US

(21) Appl. No.: 11/543,408

(22) Filed: Oct. 4, 2006

(30) Foreign Application Priority Data
Oct. 6, 2005 (MX) PA/U/2005/000245

(51) Int. Cl. E06B 3/48

(52) U.S. Cl. 160/183

(57) ABSTRACT

A system to protect the openings of finished buildings against extreme weather conditions comprising a channel frame, having a channel wherein a weather resistant protective sheet is inserted to protect against hurricanes, tornadoes, typhoons and the like. The system is installed over an opening, which may be a door, a window, a dome, a skylight or any other opening originally designed in the construction of the building or made in a subsequent improvement to the residential or commercial building. The method for assembling the frame and the installation procedure to place it over the opening to be protected is also included.

### CROSS-REFERENCE TO RELATED APPLICATIONS

This application claims priority to Mexican Utility Model Patent Application PA/u/2005/000245 filed on Oct. 6, 2005, the contents of which are hereby incorporated by reference in its entirety.

### BACKGROUND OF THE INVENTION

1. Field of the Invention

This invention refers to a protective system for doors and windows against hurricanes and other adverse weather conditions, which can be left installed and ready to face weather contingencies or be setup quickly and easily when needed. If so desired the protective system can be uninstalled when the emergency is over.

2. Description of the Related Art

Shattered windows are one of the main damages inflicted upon housing units, whether buildings and houses as well as stores in towns and cities located in the areas caught in the path of hurricanes, tornadoes, typhoons, tropical or torrential rains, or similar weather conditions, either by the action of the wind or by an object blown by it.

Equally, the doors of the housing and commercial units are affected by adverse weather conditions, especially if they are made of glass or are just ornaments, because adornment building materials are not rigid and are not designed to withstand such contingencies.

Nowadays, hammering wood sheets over the doorframes and window frames, a process that has many inconveniences, carries out the protection of doors and windows against gusts of wind caused by hurricanes and similar events.

The main inconvenience is the time spent to install the protection over all the doors and windows of the building.

The installation of protections over doors and windows is more difficult on the upper floors of the building, because it requires lots of personnel working against the clock before the gale arrives to the corresponding housing zone.

The cost of the material to be used in the protection and the availability of properly sized wood sheets to cover all the windows and doors of the building can also be considered inconveniences. And besides, these materials tend to run out during the raining season due to an excess of demand. In the other hand, after the raining season is over, the material used to protect doors and windows is thrown away, because storing it is not practical due to the required space inside the buildings, likewise, when the wood gets wet it swells and gets destroyed, originating the repurchase of new material at the start of every raining season. This leads to cutting trees to produce new sheets, and therefore contributes to the national and worldwide ecological deterioration.

It is true several effective ways to protect doors and windows against gusts of wind caused by hurricanes and similar phenomena exists, such as US patent application 2003/0159373 submitted by Shihwei Lien and published on Aug. 28, 2003, which refers to a device having two parallel and opposed rotatable U-shaped rails, installed in the upper and lower sections of the windows, through which the protective sheet is slid into position and fixed by other means. The greatest inconveniences of this system are that some of the fixing systems require the intervention of a specialized technician. The protective sheet can only be inserted laterally and from the opposite side to the fixing end, it cannot be inserted from top to bottom and cannot be installed in the windows of the upper floors.

U.S. Pat. No. 6,263,949, granted on Jul. 24, 2001 in favor of William J. Guthrie Jr. protects a system having a fixed structure over the window frame or doorframe and a screen that protects the door or window placed between the structure of the invention and a containment bar fixed to the structure of the invention. The main inconvenience is that the installation of the structure of the system needs to be carried out by a specialized technician; besides it projects out too much around the opening to be protected and it cannot be installed over some types of construction material.

U.S. Pat. No. 6,047,500, granted on Apr. 11, 2000 to Transmatic, Inc. refers to a mounting bracket and window shield assembly. The mounting bracket is presses snugly into position between the window glass and its existing frame or channel. It is designed to protect the glass windows of various public transportation vehicles, especially against vandalism. However, it may be installed in some windows of buildings, but not in all of them because the protector for the window is not suitable for all types of windows.

### SUMMARY OF THE INVENTION

1—To provide a protective system for doors and windows against the gusts of wind caused by hurricanes, tornadoes, typhoons and the like, the system components may be either marketed in separate pieces, or in kits ready to be assembled, that may be customized for the particular needs of the customer.

2—To provide a protective system for doors and windows against the gusts of wind caused by hurricanes, tornadoes, typhoons and the like, that may be partially installed on site according to the specific requirements of the user, leaving it just ready to be fully installed at the start of the raining, hurricane and tornado season.

3—To provide a protective system for doors and windows against the gusts of wind caused by hurricanes, tornadoes, typhoons and the like, that makes it easier to protect the upper floors of buildings, this being a serious matter because the time frame to set up the protections is usually very short, and dependant on the meteorological reports aired in times of extreme weather conditions.

4—To provide a protective system for doors and windows against the gusts of wind caused by hurricanes, tornadoes, typhoons and the like, that is friendly to the environment, by greatly reducing the consumption and waste of forest woods.

5—To provide a protective system for doors and windows against the gusts of wind caused by hurricanes, tornadoes, typhoons and the like, that allows the user to complete the installation without any help because it is not necessary to employ specialized personnel to complete the installation of the system.

6—To provide a protective system for doors and windows against the gusts of wind caused by hurricanes, tornadoes, typhoons and the like, so that it protects the doors and windows against the objects blown by the gusts of wind.

Other objectives of the present invention will be evident for a skilled in the art, based upon the detailed description, the attached drawings, and the following claims.

### BRIEF DESCRIPTION OF THE DRAWINGS

The features and inventive aspects of the present invention will be more evident by reading the detailed description, the claims and the drawings, which consists of:

FIG. 1 is a front view of the system of the invention placed over a window.

FIG. 2 is a ¾-perspective view of the channel section used to build the frame of the system of the invention.

FIG. 3 is a ¾-perspective view of a 90° cross-section of the channel section of FIG. 2.

FIG. 4 is ¾-perspective view of the channel section of FIG. 2 with a 90° fold.

FIG. 5 is a ¾-perspective view of the channel section of FIG. 2 that shows the introduction of the protective sheet for doors and windows in the frame.

FIG. 6 is a ¾-perspective view of the system of the invention.

FIG. 7 is a front view of the frame of the system of the invention while the protective sheet is introduced in the frame already installed over a window.

### DETAILED DESCRIPTION OF THE PREFERRED EMBODIMENT

### Definitions:

For simplicity sake, hurricanes and the like, is an expression that herein means hurricanes, tornadoes, typhoons, tropical rains, torrential rains or any climatic contingency of such intensity that it forces the implementation of protective measures, either individual or collective. Likewise, the terms adverse weather conditions and climatic contingencies will be considered synonyms to the term defined above.

Herein, opening will mean any designed open area in a construction, used for placing a door or a window, whether the door or window is used as an entrance or exit or is just an ornament or is permanently closed, like a skylight or dome, whether is located on a wall or on a roof.

Herein, any reference to doors, windows or openings makes no difference, except if a distinction in size is applicable or as otherwise noted.

The terms portion, section, segment, and arm are synonyms that define a side of the frame of the invention, unless they are used to define other part of the frame or other component related to the invention.

The terms house, apartment, office and store will be used indistinctively to refer to a building where people dwell, live in and/or work and that contains valuables or diverse objects that need to be protected.

Embodiments of the present invention were designed to protect doors and windows, whether they can be opened or not.

Embodiments of the invention relate to a protective system for openings in a finished building against hurricanes, tornadoes, typhoons and the like, comprising in a channel frame installed over the opening, and wherein a weather resistant sheet may be inserted. The method for assembling the frame and the installation procedure over the opening to be protected are also included in embodiments of this invention.

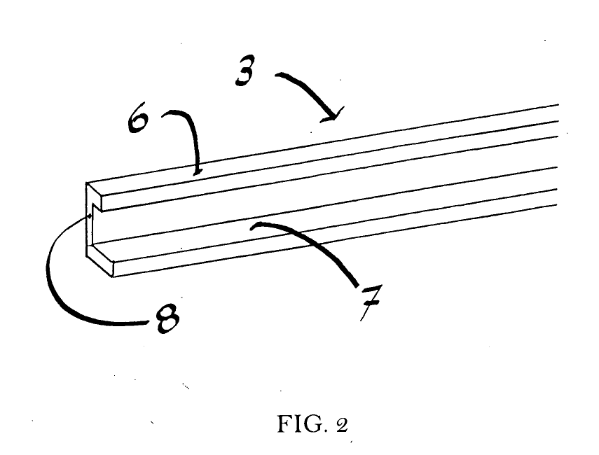

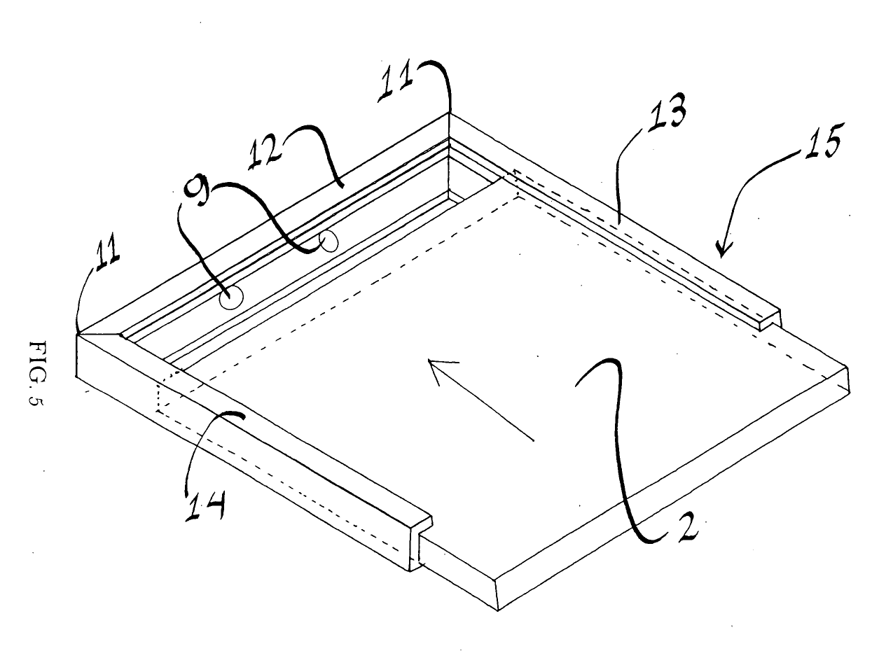

From FIG. 2 to FIG. 5 the assembling process of the frame is described (15, FIG. 5), the frame has a horseshoe shape with three straight closed sides and one open side, and it can be placed over an opening in a building prior to a climatic contingency and will be closed when the need for protection arises.

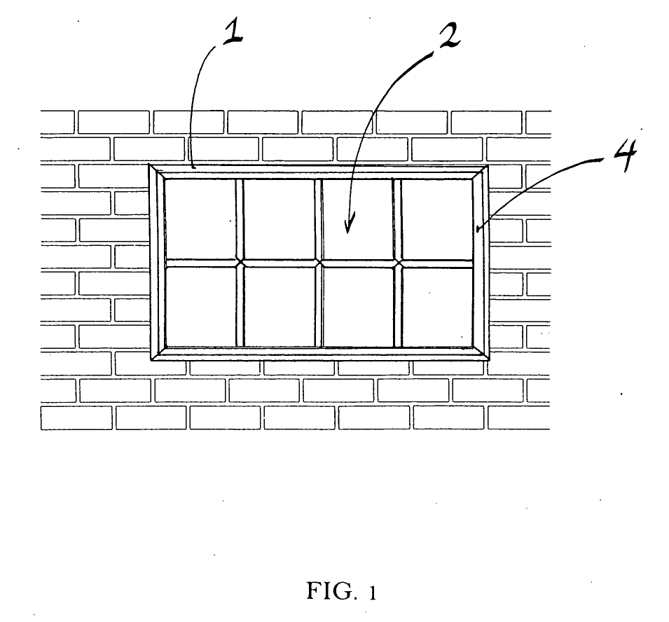

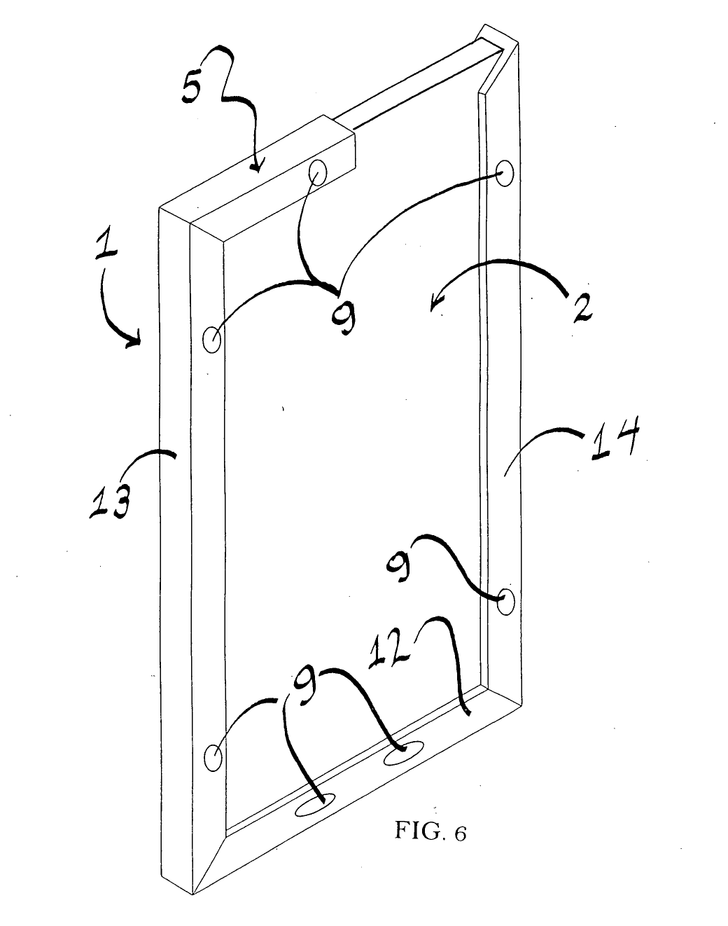

FIG. 1 illustrates the protective system of the invention in a finished building to protect against hurricanes, tornadoes, typhoons and the like, that consists in a channeled frame (1) having a channel wherein a weather resistant protective sheet is inserted. The frame (1) is formed of a channel section (3, FIG. 2) of the shape of a straight horseshoe (15, FIG. 5) which is installed over the opening (4) to be protected. When the need for protection arises, the protective sheet is slid into the frame (2) and a channel section segment (5, FIG. 6) is placed in so as to close the horseshoe frame (15).

The term “frame of the invention” or just “frame” refers to the frame shaped structure having 4 closed sides, whereas the term “‘U’ shaped frame” refers to the very same structure, but having 3 connected sides and one open side.

The opening (4) in the building is any opening originally designed in the construction of a residential building or store that is used as a door, window, dome, skylight or the like, and even any opening not originally planned made after the building is completed.

The protective sheet (2) is a square or rectangular flat structure made of a material strong enough to withstand from torrential rains to a very strong hurricane, and light enough to be easily installed by young people, not skilled in handling tools. The material of the protective sheet (2) is any material strong and light enough, selected among aluminum, several types of plastics, polyethylene and polycarbonate. The preferred material is high density polyethylene (HDP) because it can be cut to size according to the requirements of the user by using domestic tools, such as an electric saw or handsaw.

FIG. 2 shows a “J” shaped channel section or rail (3) used to form the frame (1). The “J” shaped channel section or rail (3) is comprised by two parallel arms, a short one (6) belonging to the short arm of the “J”, and a long one (7) belonging to the long arm of the “J”, joined by a portion orthogonal (8) to the parallel arms, in which the distance between the short (6) and long (7) sides is variable, but enough to allow snugly placing the protective sheet (2), so that the protective sheet is not loose once placed between the parallel short (6) and long (7) arms, but leaving enough room so that the protective sheet (2) easily slides into the ‘U’ shaped frame (15). The short (6) and long (7) arms have the same thickness, ranging from approximately 4 to 25 mm, enough so the frame (1) is not bent or warped while facing the strong gusts of wind caused by adverse weather or the impact of objects blown by the wind. The gap between the short (6) and long (7) parallel arms ranges from approximately 4 mm to 25 mm, likewise the thickness of the protective sheet (2) ranges from approximately 4 to 25 mm. The thickness of the protective sheet (2) is preferably equal to the gap between the short (6) and long (7) arms, so that thee protective sheet (2) fits and slides freely into the gap.

The material of the channel section (3) used to assemble the frame (1) can be cut to size according to the requirements of the user by using domestic tools, such as an electrical saw or a handsaw. The system is easy to install, even by young people without experience in handling tools.

The material of the channel section (3) is a lightweight and resistant material, selected among aluminum, polyethylene, steel and wood. Aluminum is the preferred material since is strong enough to withstand from a torrential rain to a very strong hurricane and light enough so it can be easily installed by young people not skilled in handling tools.

Users can purchase the channel section (3) to assemble the frame (1) according to their needs, or they can purchase the completed frame (2) to suit their requirements. Likewise, users can acquire the protective sheet (2) either cut to size or in a standard dimension that can be cut down according to their needs.

The protective system described herein fits over openings in a building to protect against hurricanes, tornadoes, typhoons and the like, is easily installed over the frame of the opening (4) on the outside of the building by using nails, screws, rivets or any other similar fastening means (9). If the system cannot be installed from the outside of the openings (4) because of the type of construction or the difficulty to install on upper floors in tall buildings or due to any other reason, the system can be easily installed on the inside of the building; the glass window will be exposed, but the people, furniture and objects inside will be protected effectively. To overcome the difficulty of installing on the upper floors of buildings, the maintenance personnel that clean the windows using gondolas may carry out the installation. The management or the security personnel of the building would undertake the installation procedure. Likewise, the system would become part of the security outfit of the building.

When the hurricane, tornado or typhoon season is over, the protective sheets (2) and the closing sections (5) are removed and stored in any suitable location inside the building. Storage of these pieces is simple, and the protective sheets (2) can be numbered according to their corresponding opening (4).

Process to Assemble the Protective System

The protective system can be assembled through the following process.

Start by measuring the opening (4) to be protected, a door, a window, a skylight, a dome or any other opening in a residential or commercial building.

Estimate at least 1¼ inch (approximately 3.2 cm) extra for each side in addition to the frame length of the opening (4) to be protected. This measurement depends on the size of the frame for the opening (4) to be protected, the proximity of the opening (4) with other objects and the ease of drilling the frame for the opening (4), or the type of construction material near the opening (4).

The equivalent of the length of one of the vertical sides of the opening to be protected is measured over a channel rail (3) plus 1¼ inch (approximately 3.2 cm) extra estimated on the base of the opening (4).

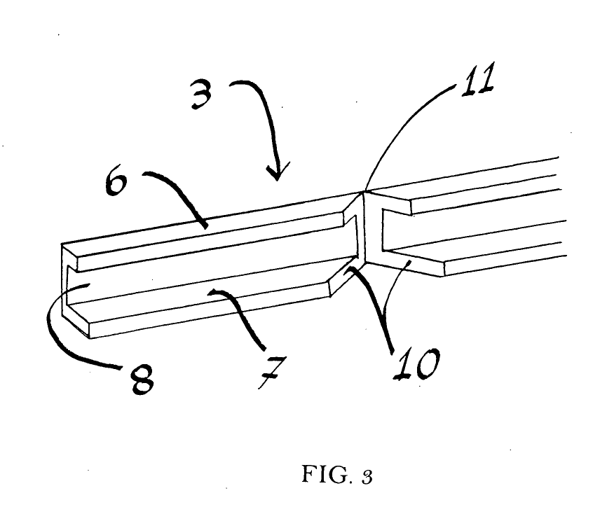

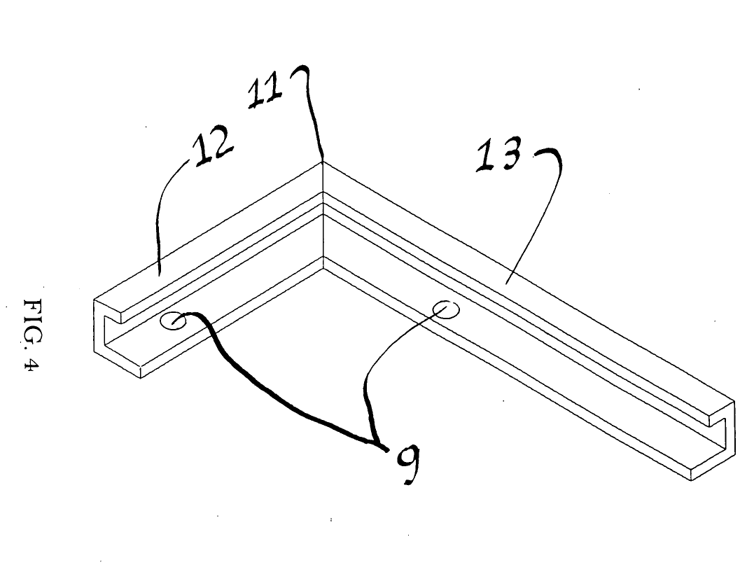

A 45° cut (beveled) is made on the section (3, FIG. 3) with a suitable tool, according to the material of the section (3); for example a domestic electric saw or handsaw. Another 45° cut is made opposite the first cut so that the section (3) has a 90° cut (FIG. 4) resulting in two segments of section (3), where the ends of each segment face each other and the segments are joined at the point (11) where the cuts are joined.

Segments (10) are joined by making folds over the joining point (11) of the segments (10) forming a 90° angle (FIG. 4). The cuts and folds are done twice, to obtain two straight angles (FIG. 5), considering that between the two straight angles there should be 1¼ inch (approximately 3.2 cm) extra on each side of the segment orthogonal (12) to the parallel side segments (13, 14, FIG. 5), an open frame with a straight horseshoe shape is assembled (15, FIG. 5) with a separation of approximately 2.5 inches (6.5 cm) between the straight angles longer than the length of the opening (4) to be protected.

The next straight parallel segment (14) is cut to the same length and in parallel to the first segment (13), with 1¼ inch (approximately 3.2 cm) extra under the original frame of the opening to be protected.

Once the frame of the protective system against hurricanes, tornadoes, typhoons and the like is assembled, 45° cuts on each end of the channel section (3) are made, so that the slant cut faces inwards the ‘U’ shaped frame (15). Subsequently, it is fixed over the frame of the opening (4) and whenever protection is needed, the protective sheet (2) is slid into the groove of the channel section (3).

The segment of the channel section (5) that closes the ‘U’ shaped frame (15) is placed so as to fit perfectly into the 45° cuts of the parallel segments (13, 14) of the ‘U’ shaped frame (15), and the 45° cuts at the ends of the channel section segment (5) that closes the ‘U’ shaped frame (15), which is fixed to the original frame of opening (4) by any fastening means (9), so the protective sheet (2) is fixed to the frame of the opening (4), that way the whole system, frame (1) and protective sheet (2), are firmly fixed to the frame of opening (4). Frame (1) of the protective system can be designed so that the protective sheet (2) slides from side to side (left to right or vice versa) or from top to bottom.

In case opening (4) is a door, a series of wooden posts or a similar structure the size that fit the frame of opening (4) can be installed over the frame of opening (4) in an orthogonal position and fixed by any fastening means (9) to the frame of opening (4), so the ‘U’ shaped frame (15) of the system can be installed over this posts without obstructing the lock or any other means to open or close the door. On the other hand, a wood frame or similar can be installed parallel over the frame of the door without obstructing the lock mechanism, the ‘U’ shaped frame (15) then would be installed over this frame. Once the ‘U’ shaped frame (15) is in place having the open end on one side, the protective sheet (2) is slid through the open side and the ‘U’ shaped frame is closed with the channel section segment (5), which is fixed to the system in the manner described above. This procedure can be done from inside the building, but the outer surface of the door would not be protected from the adverse weather.

If the user is in a hurry and chooses to do so, he/she can fix the protective sheet (2) by any suitable fastening means (9) directly to the doorframe.

The material of the channel section (3) used to assemble the frame (1) is selected among aluminum, polyethylene, steel and wood; the preferred material for the frame is aluminum. The material of the protective sheet is any material sufficiently strong and light, selected among several types of plastics, polyethylene and polycarbonate; the preferred material is high density polyethylene (HDP), which can be cut to size according the requirements of the user by using domestic tools such as an electrical saw or handsaw.

Once the frame of the system is shaped like a straight horseshoe (15), it can be installed over the original frame of opening (4). It can remain like that until the time comes to complete the installation when a climatic contingency is declared. When this happens the protective sheet (2) is introduced in the rail of the ‘U’ shaped frame through the open side and the system is capped with the other channel section segment (5) that is fixed to the original frame of opening (5) in the same manner as the frame.

FIG. 6 partially shows segment (5) that caps the ‘U’ shaped frame (15, FIG. 5) in order to show the protective sheet (2) in place. This segment (5) completely covers the protective sheet (2) completing the frame (1).

Installation Process of the Frame

The straight ‘U’ shaped frame (15) can be placed with the open side facing upwards or sideways, either to the left or to the right. When the open end is to be faced upwards it is irrelevant which side, left or right, (13, 14) of the straight ‘U’ shaped frame (15) is installed first over the frame of the opening (4). However, when the open side faces sideways, it is recommended to install first the segment of the straight ‘U’ shaped frame (15) that goes on top of the frame of the opening (4) to be protected, then the middle section (12) of the straight ‘U’ shaped frame (15), and finally the bottom side (13, 14) of the straight ‘U’ shaped frame (15).

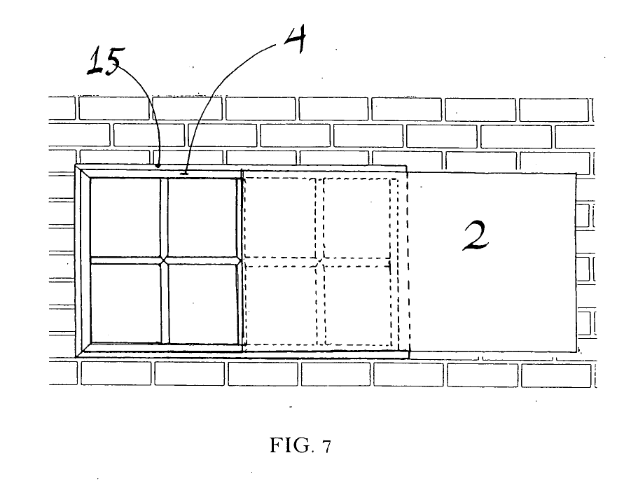

FIG. 7 shows a front view of the window from the outside, and the straight ‘U’ shaped frame (15) installed over the window with the open side facing to the right of the window.

The straight ‘U’ shaped frame (15) is installed over the frame of the opening (4) to be protected, and fixed with nails, screws, rivets or any other similar effective fastening means (9).

The protective system is installed by fixing one of the parallel sides (13, 14) of the ‘U’ shaped frame (15) with fastening means (9), then the segment (12) orthogonal to the parallel sides is fixed, and finally the other parallel side (13, 14) is fixed with the same fastening means (9). The number of fastening means (9) necessary to fix each open segment of the straight ‘U’ shaped frame (15) depends on the length of each side (12, 13, 14). The system is designed so that the open straight ‘U’ shaped frame (15) may be left installed over the opening (4) well before any protection is needed, in order to save time and work before the start of the hurricane, tornado and typhoon season. When a climatic contingency occurs, the protective sheet (2) slides through the channel section of the open straight ‘U’ shaped frame (15), then the last segment (5) of channel section is placed and fixed to the original frame of the opening (4) to be protected, just like the other segments of the protective frame. The arrow in FIG. 5 indicates the direction of the protective sheet (2) when being inserted in the open straight ‘U’ shaped frame (15).

The parallel segments (13, 14) of the open straight ‘U’ shaped frame (15) have 45° cuts at their free ends directed towards the interior of the frame. Likewise, segment (5) placed to cap the frame after sliding the protective sheet (2) has 45° cuts at its ends so it can fit on the open straight ‘U’ shaped protective frame (15) already installed over the opening (4) in the building.

The protective system can be easily installed over the frame of opening (4) from the outside by any adult person, even with the help of pre-adolescent children. When it is not possible to install the system from outside the construction, the protective system can easily be installed over the frame of the opening (4) from the inside; in such scenario the glass windows and doors are not protected, but the people, the furniture and the interior of the building are kept safe.

When the hurricane, tornado or typhoon season is over, the protective sheets (2) and the closing sections (5) would be removed and stored in any suitable location inside the house or apartment. Storage of these pieces is simple: the protective sheets (2) can be numbered according to their corresponding opening.

Along with the protective sheets (2) and the numbered closing sections (5), the blueprints of the distribution of windows in the building and the fastening means (9) should be stored in a designated location with proper instructions and become part of the emergency system of the residential or commercial building.

The standard protective sheet (2) can measure approximately 8 feet in length and 4 feet in width (approximately 2.40×1.20 meters), sufficient to protect a standard door. It can also be cut to different sizes according to the users requirements.

The standard channel section (3) may have a minimum length of approximately 8 feet (approx. 2.40 meters), thus three channel sections (3), two of full length, and one of half the length are required to assemble the frame for a standard protective sheet (2). If needed, the channel section can also be cut to size according to the user's requirements.

Embodiments of the invention were designed so that the materials may be marketed through several types of establishments, either as materials of different sizes, such as sections (3, 5, 12, 13 and 14) and protective sheets (2), and the user can cut them to size according to their requirements, or marketed as a complete product with standard sizes or custom sizes for special requirements.

The preferred embodiments of this invention have been described, and obviously a person with average technical knowledge will be able to make modifications and changes based o n the information described herein. It should be understood that within the scope of the following claims, the invention might be carried out in different ways than the one described in the preceding specification.

What is claimed is:

1. A system to protect openings of finished buildings against extreme weather conditions, comprising a channel frame and a weather resistant protective sheet, wherein the protective sheet is inserted into the channel so as to protect the openings of a building against said extreme weather conditions.

2. The system of claim 1, wherein the frame is formed by a ‘U’ shaped channel section which is installed over the opening to be protected, and when said extreme weather condition occurs, the protective sheet is slid into said frame to protect said opening.

3. The system of claim 1, wherein the frame is made from aluminum, polyethylene, steel, or wood.

4. The system of claim 1, wherein the frame is made of a material that is strong enough to withstand said extreme weather conditions, but lightweight enough to be installed by a single person.

5. The system of claim 2, wherein the frame is formed from J-shaped sections or rails.

6. The system of claim 5, wherein the J-shaped section or rail is formed from two parallel arms,, with one short arm belonging to the short portion of the “J”, and another long arm belonging to the long portion of the “J”, the long arm being joined by a portion orthogonal to the two parallel arms, wherein the distance between the short and long sides is variable, but allows the protective sheet slide snugly into position within the channel frame.

7. The system of claim 2, wherein said openings in said buildings are doors, windows, domes, skylights or the like.

8. The system of claim 1, wherein the protective sheet is a square or rectangular structure.

9. The system of claim 8, wherein the protective sheet is made from plastic, polyethylene, polycarbonate or a high density polyethylene (HDP).

10. The system of claim 1, wherein the protective system is installed in said opening using nails, screws, rivets or any other similar fastening means.

11. The system claim 1, wherein said protective system is adapted to be installable from inside said building.

12. A process to assemble the protective system against extreme weather conditions, comprising:
(a) measuring the opening to be protected;
(b) estimating at least 1 ¼ inch (approximately 3.2 cm ) extra for each side over the frame of the opening to be protected;
(c) the equivalent of the length of one of the vertical sides of the opening to be protected is measured over a channel rail adding 1 ¼ inch (approximately 3.2 cm ) extra estimated on the base of the opening;
(d) making a 45° beveled cut on the section; making another 45° cut opposite the first cut so that the section has a 90° cut resulting in two segments of the section where the ends of each segment face each other and the segments are joined at the point where the cuts join;
(e) joining the segments by making folds over the joining point of the segments, wherein said cuts and folds are performed twice to obtain two straight angles wherein between the two straight angles there should be approximately 1¼ extra on each side of the segment orthogonal to the parallel segments;
(f) cutting the next straight parallel segment to the same length and parallel orientation to the first segment described in (c), with 1¼ inch extra under the original frame of the opening to be protected;
(g) making 45° cuts on each end of the channel section, so that a slant faces inwards the ‘U’ shaped frame (15) and is fixed over the frame of the opening and configured so that the protective sheet can be slid into the channel of the channel section;
(h) placing the segment of the channel section that closes the ‘U’ shaped frame so that it fits in the 45° cuts of the parallel segments of the ‘U’ shaped frame and the 45° cuts at the ends of the channel section segment that closes the ‘U’ shaped frame, that is fixed to the original frame of the opening by a fastening means, so that the protective sheet is fixed to the frame of the opening, thereby the frame and the protective sheet are firmly fixed to the frame of the opening and the frame (1) is designed so that the protective sheet slides from side to side or from top to bottom.

13. The process of claim 12, wherein the frame is made of a material selected from aluminum, polyethylene, steel or wood.

14. The process of claim 12, wherein the protective sheet is made of plastic, polyethylene, polycarbonate or high density polyethylene (HDP).

15. The process of claim 12, wherein the frame of the system is adapted to remain installed over the original frame of the opening to be protected.

16. The process of claim 12, wherein the protective sheet is configured to be introduced in the rail of the frame through the open side and the system is capped with another channel section segment that is then fixed to the original frame of the opening.

17. A method of installing a protective system against extreme weather conditions, comprising providing the system of claim 1, and installing said frame over an opening in a building to be protected.

18. The method of claim 17, wherein said frame is installed over said opening from the outside of said building.

19. The method of claim 17, wherein said frame is installed over said opening from the inside of said building.

20. The method of claim 17, wherein the protective system is installed by fixing one of the parallel sides of the ‘U’ shaped frame with fastening means, then fixing a segment orthogonal to the parallel sides, and finally fixing a parallel side with a fastening means.

21. The method of claim 20, wherein the number of fastening means necessary to fix each open segment of the straight ‘U’ shaped frame relates to the length of each side.

22. The method of claim 21, wherein the frame is adapted to be left installed over the opening well before any protection is needed.

23. The method of claim 21, wherein the protective sheet, which is removable, is slid through the channel section of the open straight ‘U’ shaped frame, and then, the last channel section segment is placed and fixed to the original frame of the opening to be protected.
